(19) United States
(12) Patent Application Publication
(10) Pub. No.: US 2008/0150456 A1
(43) Pub. Date: Jun. 26, 2008

(54) APPARATUS AND METHOD FOR CONTROLLING OPERATION OF RECIPROCATING COMPRESSOR

(75) Inventors: Kyung-Bum HEO, Gyeonggi-Do (KR); Jae-Yoo YOO, Gyeonggi-Do (KR); Ji-Won SUNG, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/618,139

(22) Filed: Dec. 29, 2006

(30) Foreign Application Priority Data
Jan. 6, 2006 (KR) 10-2006-0002007

(51) Int. Cl. H02P 1/00

(52) U.S. Cl. 318/119

(57) ABSTRACT

An apparatus and method for controlling an operation of a reciprocating compressor are disclosed. The apparatus for controlling an operation of a reciprocating compressor includes: a current phase delay value generating unit that calculates a current phase delay value by using a current stroke and a detected current and outputting the calculated current phase delay value; and a reference current generating unit that delays a reference current based on a difference between the current stroke and a stroke reference value according to the current phase delay value. A phase difference between a current and a pulse width modulation (PWM) voltage is estimated, a phase delay value for compensating the estimated phase difference is calculated, and a reference current is delayed as much as the calculated phase delay value for a certain time to thus remove a current distortion phenomenon. Therefore, an operation efficiency of the reciprocating compressor can be enhanced and a precision degree in controlling a top dead center (TDC) can be improved.

### RELATED APPLICATION

The present disclosure relates to subject matter contained in priority Korean Application No. 10-2006-0002007, filed on Jan. 6, 2006, which is herein expressly incorporated by reference in its entirety

### BACKGROUND OF THE INVENTION

1. Field of the Invention

The present invention relates to a compressor and, more particularly, to an apparatus and method for controlling an operation of a reciprocating compressor.

2. Description of the Related Art

In general, a reciprocating compressor is operated to suck, compress and discharge a refrigerant gas by reciprocally and linearly moving a piston in a cylinder provided therein.

The reciprocating compressor is divided into a compressor using a recipro method and a compressor using a linear method according to how the piston is driven.

In the compressor using the recipro method, a crank shaft is coupled with a rotary motor and the piston is coupled with the crank shaft in order to change a rotating force of the rotary motor to a reciprocating motion.

In the compressor using the linear method, the piston connected with an actuator of a linear motor is linearly moved.

The reciprocating compressor using the linear method does not have such a crank shaft for changing the rotational motion into the linear motion, causing no frictional loss by the crank shaft, so it has high compression efficiency compared with a general compressor.

The reciprocating compressor can be employed for a refrigerator or an air-conditioner to control cooling capacity of the refrigerator or the air-conditioner by varying a compression ratio of the reciprocating compressor which can be varied by changing voltage inputted the motor of the reciprocating compressor.

Thus, when the reciprocating compressor is employed for the refrigerator or the air-conditioner, the cooling capacity can be controlled by varying the compression ratio of the reciprocating compressor by varying a stroke voltage inputted to the reciprocating compressor. Herein, the stroke refers to a distance between a top dead center and a bottom dead center of the piston.

The reciprocating compressor according to the related art will now be described with reference to FIG. 1.

FIG. 1 is a schematic block diagram showing the construction of an apparatus for controlling an operation of the reciprocating compressor.

As shown in FIG. 1, the related art apparatus for controlling an operation of the reciprocating compressor includes: a current detection unit 4 for detecting current applied to a motor (not shown) of a reciprocating compressor 6; a voltage detection unit 3 for detecting voltage applied to the motor; a stroke calculation unit 5 for calculating a stroke estimate value of the reciprocating compressor 6 based on the detected current and voltage values and a parameter of the motor; a comparing unit 1 for comparing the calculated stroke estimate value with a pre-set stroke reference value and outputting a difference value according to the comparison result, and a stroke control unit 2 for controlling an operation (stroke) of the compressor 6 by varying the voltage applied to the motor by controlling a turn-on period of a triac (not shown) connected in series to the motor according to the difference value.

The operation of the apparatus for controlling an operation of the reciprocating compressor will now be described with reference to FIG. 1.

First, the current detect unit 4 detects current applied to the motor (not shown) of the compressor 6 and outputs the detected current value to the stroke calculation unit 5.

At this time, the voltage detection unit 3 detects voltage applied to the motor and outputs the detected voltage value to the stroke calculation unit 5.

The stroke calculation unit 5 calculates a stroke estimate value (X) of the compressor by substituting the detected current and voltages values and the parameter of the motor to equation (1) shown below and applies the calculated stroke estimate value (X) to the comparing unit 1

$$X = \frac{1}{α} \int ( {V}_{M} - Ri - L \overline{i} ) d t \qquad ( 1 )$$

wherein ‘R’ is a motor resistance value, ‘L’ is a motor inductance value, α is a motor constant, V_{M} is a voltage value applied to the motor, ‘i’ is a current value applied to the motor, and ī is a time change rate of the current applied to the motor Namely, ī is a differential value (di/dt) of ‘i’.

Thereafter, the comparing unit 1 compares the stroke estimate value and the stroke reference value and applies a difference value according to the comparison result to the stroke control unit 2.

The stroke control unit 2 controls stroke of the compressor 6 by varying the voltage applied to the motor of the compressor 6 based on the difference value.

This operation will now be described with reference to FIG. 2.

FIG. 2 is a flow chart illustrating the processes of a method for controlling an operation of the reciprocating compressor according to the related art.

First, when the stroke estimate value is applied to the comparing unit 1 by the stroke calculation unit 5 (step S1), the comparing unit 1 compares the stroke estimate value and a pre-set stroke reference value (step S2) and outputs a difference value according to the comparison result to the stroke control unit 2.

When the stroke estimate value is smaller than the stroke reference value, the stroke control unit 2 increases the voltage applied to motor to control the stroke of the compressor (step S3), and when the stroke estimate value is greater than the stroke reference value, the stroke control unit 2 reduces the voltage applied to the motor (step S4).

When the voltage applied to the motor is increased or reduced, the triac (not shown) electrically connected with the motor control the turn-on period and applies the voltage to the motor.

The stroke reference value differs depending on a size of a load of the reciprocating compressor. Namely, when the load is large, the stroke reference value is increased not to reduce the stroke of the piston and prevent degradation of cooling capacity. Conversely, when the load is small, the stroke reference value is reduced not to increase the stroke of the piston and prevent an increase of the cooling capacity and generation of collision of the piston and the cylinder due to an excessive stroke (over-stroke).

In an apparatus for controlling an operation of the reciprocating compressor according to another embodiment of the related art, stroke of the reciprocating compressor is controlled by varying voltage applied to the reciprocating compressor by using an inverter.

In the apparatus for controlling an operation of the reciprocating compressor by using the inverter. A PWM (Pulse Width Modulation) voltage for controlling switching of the inverter is set as a function of sine wave with the same phase as a reference current.

Namely, the PWM voltage is generated as being obtained by multiplying a certain gain to a difference between the reference current and an actual current flowing at the reciprocating compressor.

However, the current flowing at the reciprocating compressor has a phase difference with the PWM voltage, so it is not possible to control the current in a precise sine wave form.

Thus, the related art reciprocating compressor using the inverter has the following problems. That is, current is distorted to generate a loss of current harmonics, operation efficiency is degraded.

In addition, the current distortion phenomenon causes an error in measuring the phase difference between the current and stroke, so the stroke cannot be precisely controlled.

### BRIEF DESCRIPTION OF THE INVENTION

Therefore, an object of the present invention is to provide an apparatus and method for controlling an operation of a reciprocating compressor in which a phase difference between current flowing at a reciprocating compressor employing an inverter and a PWM voltage to calculate a phase delay value for compensating the estimated phase difference and a reference current is delays for a certain time as much as the calculated phase delay value, thereby removing a phenomenon of current distortion.

To achieve these and other advantages and in accordance with the purpose of the present invention, as embodied and broadly described herein, there is provided an apparatus for controlling an operation of a reciprocating compressor including: a current phase delay value generating unit for calculating a current phase delay value by using a current stroke and a detected current and outputting the calculated current phase delay value; and a reference current generating unit for delaying a reference current based on a difference between the current stroke and a stroke reference value according to the current phase delay value.

To achieve the above object, there is also provided an apparatus for controlling an operation of a reciprocating compressor including: a current detection unit that detects current applied to a linear motor, a voltage detection unit that detects voltage applied to the linear motor; a stroke calculating unit that calculates stroke with the detected current and voltage; a current phase delay value generating unit that calculates a current phase delay value by using the calculated stroke and detected current and outputting the calculated current phase delay value; a first comparing unit that obtains a difference value between a stroke reference value and the calculated stroke and outputting the difference value; a reference current generating unit that delays a reference current based on the difference value for a certain time according to the current phase delay value and outputting the delayed reference current; a second comparing unit that calculates a difference value between the certain time-delayed reference current and the detected current and outputting the difference value; a PWM signal generating unit that generates a PWM signal based on the difference value of the second comparing unit, and an inverter for varying voltage and frequency applied to the motor according to the PWM signal.

To achieve the above object, there is also provided a method for controlling an operation of a reciprocating compressor including: generating a reference current based on a difference between a current stroke and a stroke reference value by delaying it for a certain time; and varying voltage applied to a linear motor with a PWM signal based on the difference between the certain time-delayed reference current and a detected current.

To achieve the above object, there is also provided a method for controlling an operation of a reciprocating compressor including: calculating a current phase delay value by using a current stroke and a detected current; delaying a reference current based on a difference between the stroke and a stroke reference value for a certain time according to the current phase delay value; and varying voltage applied to a linear motor with a PWM signal based on the certain time-delayed reference current and a detected current.

To achieve the above object, there is also provided a method for controlling an operation of a reciprocating compressor including: detecting current and voltage applied to a linear motor; calculating stroke with the detected current and voltage; calculating a current phase delay value by using the stroke and the detected current; obtaining a difference value between the stroke and a stroke reference value and generating a reference current based on the difference value; delaying the reference current for a certain time according to a current phase delay value; and calculating a difference value between the delayed reference current and the detected current, and varying voltage applied to the linear motor with a PWM signal based on the calculated difference value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic block diagram showing an apparatus for controlling an operation of a reciprocating compressor according to the related art;

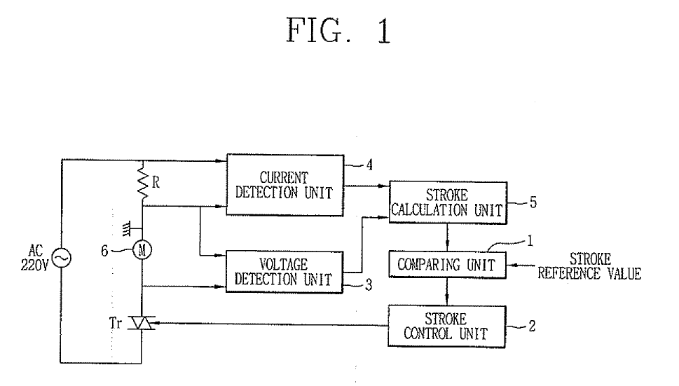

FIG. 2 is a flow chart illustrating the processes of a method for controlling an operation of the reciprocating compressor according to the related art;

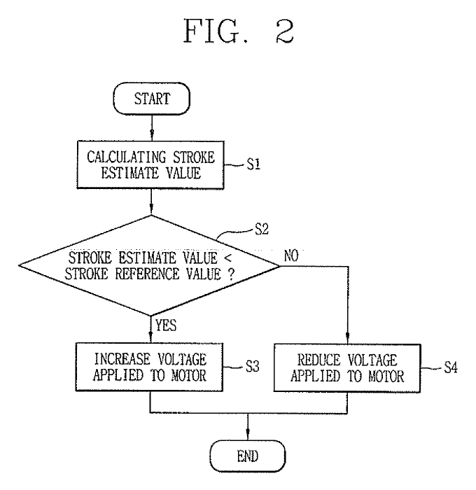

FIG. 3 shows waveforms of current and a PWM voltage of the reciprocating compressor having an inverter according to the related art;

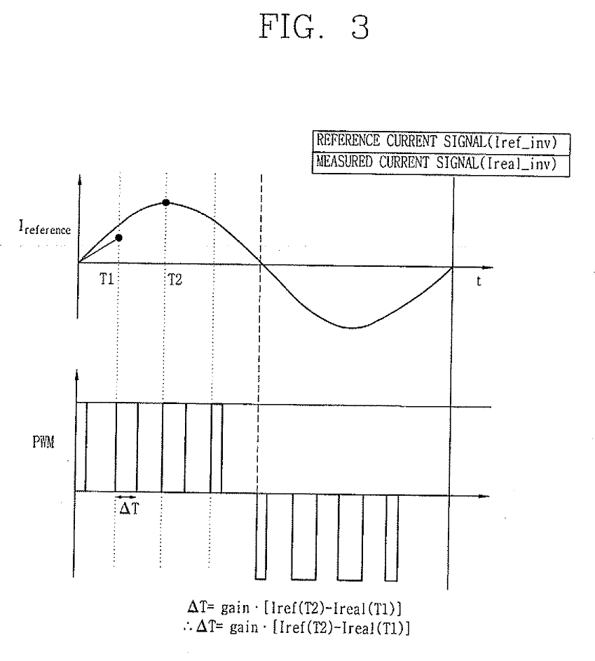

FIG. 4 shows a waveform of current distorted according to a phase difference between the PWM voltage and current in FIG. 3;

FIG. 5 is a schematic block diagram showing the construction of an apparatus for controlling an operation of a reciprocating compressor according to the present invention;

FIG. 6 is a flow chart illustrating the processes of a method for controlling an operation of a reciprocating compressor according to the present invention; and

FIG. 7 shows a waveform of current according to the present invention.

### DETAILED DESCRIPTION OF THE INVENTION

An apparatus and method for controlling an operation of a reciprocating compressor capable of improving operation efficiency of the reciprocating compressor and precision of controlling a TDC (Top Dead Center) by estimating a phase difference between current and a PWM voltage to calculate a phase delay value for compensating the estimated phase difference, and delaying a reference current for a certain time as long as the calculated phase delay value to thus prevent generation of current distortion according to the present invention will now be described as follows.

In the apparatus and method for controlling an operation of a reciprocating compressor employing an inverter, the present invention considers that a phase difference between a PWM voltage for controlling switching of the inverter and current flowing at the reciprocating compressor can be calculated by using stroke and current.

Herein, the TDC physically refers to a position of a piston when a compression stroke of the piston is completed.

A bottom dead center (BDC) physically refers to a position of the piston when a suction stroke of the piston is completed.

In this case, efficiency of the reciprocating compressor is maximized at a position where TDC is 0, so when controlling an operation of the reciprocating compressor, the piston is controlled to come to the position where TDC is 0.

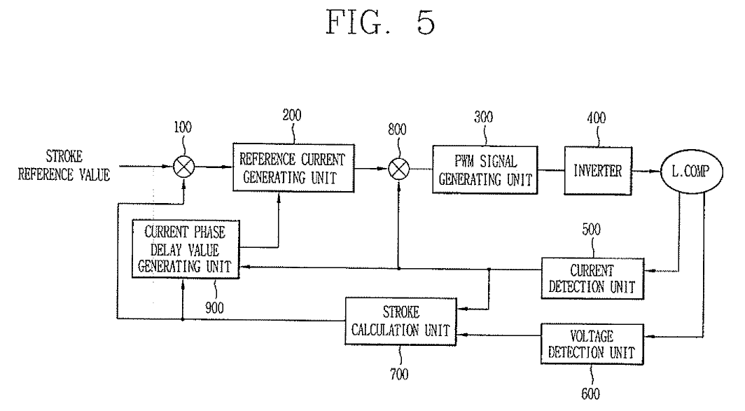

FIG. 5 is a schematic block diagram showing the construction of an apparatus for controlling an operation of a reciprocating compressor according to the present invention.

As shown in FIG. 5, the apparatus for controlling an operation of a reciprocating compressor according to the present invention includes comparing units 100 and 800, a reference current generating unit 200, a PWM signal generating unit 300, an inverter 400, a current detection unit 500, a voltage detection unit 600, a stroke calculation unit 700, and a current phase delay value generating unit 900.

The current detection unit 500 detects current of a motor of the reciprocating compressor, and the voltage detection unit 600 detects voltage of the motor of the reciprocating compressor.

The stroke calculation unit 700 calculates stroke by using the detected current and the detected voltage.

The current phase delay value generating unit 900 calculates a current phase delay value by using the stroke of the stroke calculation unit 700 and the detected current of the current detection unit 500.

Namely, the current phase delay value generating unit 900 can calculate the current phase delay value by an equation shown below:

$$\text{Phase} ( V - i ) = ∠ [ \{ jwL - j \frac{1}{cw} + R \} \cdot \vert i \vert + jw α \vert x \vert {e}^{- jθ} ]$$

The comparing unit 100 obtains a difference value between a stroke reference value and the stroke and outputs it, and the comparing unit 800 obtains a difference value between the detected current and a reference current and outputs it.

The reference current generating unit 200 delays the reference current based on the difference value of the comparing unit 100 as much as the current phase delay value, and outputs the delayed reference current.

The comparing unit 800 calculates a difference value between the reference current outputted from the reference current generating unit 200 and the current detected by the current detection unit 500, and outputs the calculated difference value.

The PWM signal generating unit 300 generates a PWM signal based on the difference value of the comparing unit 800.

Namely, when the reference current is smaller than the detected current, the PWM signal generating unit 300 reduces a duty rate of the PWM signal, and if the reference current is larger than the detected current, the PWM signal generating unit 300 increases the duty rate of the PWM signal.

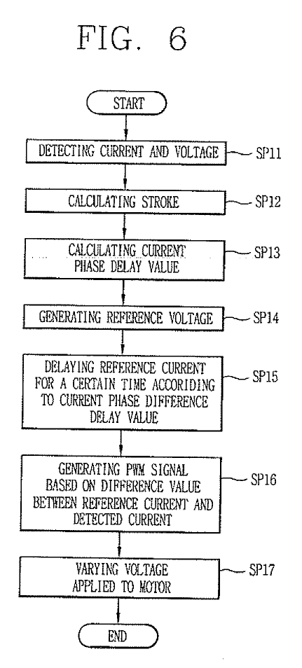

The operation of the present invention will now be described with reference to FIG. 6.

First, the current detection unit 500 detects current of the motor of the reciprocating compressor, and the voltage detection unit 600 detects voltage of the motor of the reciprocating compressor (SP11).

Next, the stroke calculation unit 700 calculates the stroke by using the detected current and the detected voltage (SP12).

And then, the current phase delay value generating unit 900 calculates a current phase delay value by using the stroke of the stroke calculation unit 700 and the detected current of the current detection unit 500 by equation shown below (SP13).

$$Let i = \vert i \vert , x = \vert x \vert {e}^{j ( wt - θ )}$$

$$\begin{matrix}V = L \frac{d i}{d t} + \frac{1}{c} \int i d t + Ri + α x \\ = ( jwL - j \frac{1}{cw} + R ) \cdot \vert i \vert {e}^{j wt} + jw α \vert x \vert {e}^{j ( wt - θ )} \\ = [ \{ jwL - j \frac{1}{cw} + R \} \cdot \vert i \vert + jw α \vert x \vert {e}^{- jθ} ] \cdot {e}^{j wt} \\ = \hat{V} \cdot {e}^{j wt}\end{matrix} \\ ∴ \hat{V} = [ \{ jwL - j \frac{1}{cw} + R \} \cdot \vert i \vert + jw α \vert x \vert {e}^{- jθ} ] \\ ∴ Phase ( V - i ) = ∠ [ \{ jwL - j \frac{1}{cw} + R \} \cdot \vert i \vert + jw α \vert x \vert {e}^{- jθ} ]$$

wherein ‘x’ is stroke.

Thereafter, the comparing unit 100 applies the difference value between the stroke reference value and the stroke and applies it to the reference current generating unit 200. Then, the reference current generating unit 200 delays the reference current based on the difference value of the comparing unit 100 as much as the current phase delay value and outputs the delayed reference current (SP14).

Namely, the reference current generating unit 200 generates the reference current by delaying it as much as a phase difference with the PWM voltage.

Subsequently, the comparing unit 800 calculates the difference value between the reference current outputted from the reference current generating unit 200 and the current detected by the current detection unit 500 and outputs it, and the PWM signal generating unit 300 generates the PWM signal based on the difference value of the comparing unit 800 (step S16).

Namely, when the reference current is smaller than the detected current, the PWM signal generating unit 300 reduces the duty rate of the PWM signal, and when the reference current is greater than the detected current, the PWM signal generating unit 300 increases the duty rate of the PWM signal.

Thereafter, the inverter 500 applies a voltage, whose frequency has been varied for the PWM signal outputted from the PWM signal generating unit 300, to the motor of the reciprocating compressor.

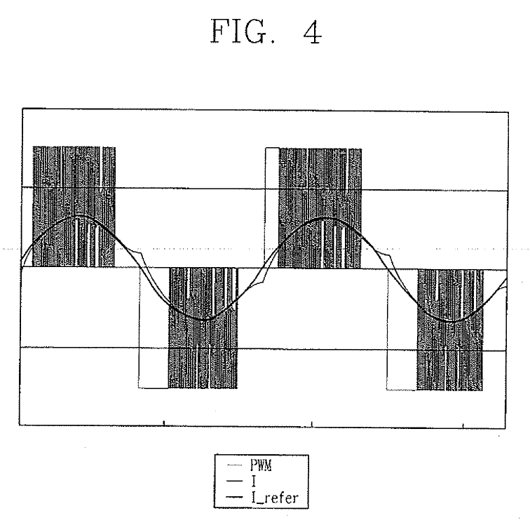

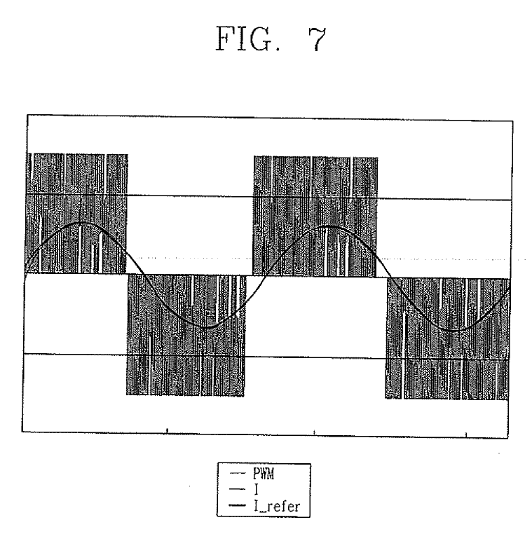

FIG. 7 shows a waveform of current according to the present invention. Compared with the current waveform in FIG. 4, it is noted that the current distortion has been almost removed.

Namely, in the present invention, the phase difference between the current and the PWM voltage is estimated and a phase delay value for compensating the estimated phase difference is calculated, and then the reference current is delayed as much as the phase calculated phase delay value for a certain time, thereby removing the current distortion phenomenon.

As so far described, the apparatus and method for controlling an operation of the reciprocating compressor has the following advantages.

That is, the phase difference between the current and the PWM voltage is estimated, the phase delay value for compensating the estimated phase difference is calculated, and the reference current is delayed as much as the calculated phase delay value for a certain time to thus remove the current distortion phenomenon. Therefore, the operation efficiency of the compressor can be enhanced and the precision degree in controlling the TDC can be improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. An apparatus for controlling an operation of a reciprocating compressor comprising:
current phase delay value generating unit for calculating a current phase delay value by using a current stroke and a detected current and outputting the calculated current phase delay value; and
a reference current generating unit for delaying a reference current based on a difference between the current stroke and a stroke reference value for a certain time according to the current phase delay value.

2. The apparatus of claim 1, further comprising:
a pulse width modulation (PWM) signal generating unit for generating a PWM signal based on a difference value between the certain time-delayed reference current and the detected current.

3. The apparatus of claim 2, wherein when the detected current is greater than the reference current, the PWM signal generating unit reduces a duty rate of the PWM signal.

4. The apparatus of claim 2, wherein when the detected current is smaller than the reference current, the PWM signal generating unit increases the duty rate of the PWM signal.

5. The apparatus of claim 1, wherein the current phase delay value generating unit calculates the current phase delay value by using an equation shown below:
$$Phase ( V - i ) = ∠ [ \{ jwL - j \frac{1}{cw} + R \} \cdot \vert i \vert + jw α \vert x \vert {e}^{- jθ} ]$$

6. An apparatus for controlling an operation of a reciprocating compressor comprising:
a current detection unit for detecting current applied to a linear motor;
a voltage detection unit for detecting voltage applied to the linear motor;
a stroke calculating unit for calculating stroke with the detected current and voltage;
a current phase delay value generating unit for calculating a current phase delay value by using the calculated stroke and detected current and outputting the calculated current phase delay value;
a first comparing unit for obtaining a difference value between a stroke reference value and the calculated stroke and outputting the difference value;
a reference current generating unit for delaying a reference current based on the difference value for a certain time according to the current phase delay value and outputting the delayed reference current;
a second comparing unit for calculating a difference value between the certain time-delayed reference current and the detected current and outputting the difference value;
a pulse width modulation (PWM) signal generating unit for generating a PWM signal based on the difference value of the second comparing unit; and
an inverter for varying voltage and frequency applied to the motor according to the PWM signal.

7. The apparatus of claim 6, wherein the current phase delay value generating unit calculates the current phase delay value by using an equation shown below:
$$Phase ( V - i ) = ∠ [ \{ jwL - j \frac{1}{cw} + R \} \cdot \vert i \vert + jw α \vert x \vert {e}^{- jθ} ]$$

8. The apparatus of claim 6, wherein when the detected current is greater than the reference current, the PWM signal generating unit reduces a duty rate of the PWM signal.

9. The apparatus of claim 6, wherein when the detected current is smaller than the reference current, the PWM signal generating unit increases the duty rate of the PWM signal.

10. A method for controlling an operation of a reciprocating compressor comprising:
generating a reference current based on a difference between a current stroke and a stroke reference value by delaying the reference current for a certain time; and
varying voltage applied to a linear motor with a pulse width modulation (PWM) signal based on the difference between the certain time-delayed reference current and a detected current.

11. The method of claim 10, wherein the varying of the voltage comprises:
when the detected current is greater than the reference current, reducing a duty rate of the PWM signal.

12. The method of claim 10, wherein the varying of the voltage comprises:
when the detected current is smaller than the reference current, increasing the duty rate of the PWM signal.

13. A method for controlling an operation of a reciprocating compressor comprising:
calculating a current phase delay value by using a current stroke and a detected current;
delaying a reference current based on a difference between the stroke and a stroke reference value for a certain time according to the current phase delay value; and
varying voltage applied to a linear motor with a PWM signal based on the certain time-delayed reference current and a detected current.

14. The method of claim 13, wherein the current phase delay value is calculated by using an equation shown below:
$$Phase ( V - i ) = ∠ [ \{ jwL - j \frac{1}{cw} + R \} \cdot \vert i \vert + jw α \vert x \vert {e}^{- jθ} ]$$

15. The method of claim 13, wherein the varying of the voltage comprises:
when the detected current is greater than the reference current, reducing a duty rate of the PWM signal.

16. The method of claim 13, wherein the varying of the voltage comprises:
when the detected current is smaller than the reference current, increasing the duty rate of the PWM signal.

17. A method for controlling an operation of a reciprocating compressor comprising:
detecting current and voltage applied to a linear motor;
calculating stroke with the detected current and voltage;
calculating a current phase delay value by using the stroke and the detected current;
obtaining a difference value between the stroke and a stroke reference value and generating a reference current based on the difference value;
delaying the reference current for a certain time according to a current phase delay value; and
calculating a difference value between the delayed reference current and the detected current, and varying voltage applied to the linear motor with a PWM signal based on the calculated difference value.

18. The method of claim 17, wherein the current phase delay value is calculated by using an equation shown below:
$$Phase ( V - i ) = ∠ [ \{ jwL - j \frac{1}{cw} + R \} \cdot \vert i \vert + jw α \vert x \vert {e}^{- jθ} ]$$

19. The method of claim 17, wherein the varying of the voltage comprises:
when the detected current is greater than the reference current, reducing a duty rate of the PWM signal.

20. The method of claim 17, wherein the varying of the voltage comprises:
when the detected current is smaller than the reference current, increasing the duty rate of the PWM signal.
